(19) United States
(12) Patent Application Publication
(10) Pub. No.: US 2016/0078033 A1
(43) Pub. Date: Mar. 17, 2016

(54) Physical Visual ID as Means to Tie Disparate Media Collections

(71) Applicant: Fernando A BRUCHER, Irvine, CA (US)

(72) Inventor: Fernando A BRUCHER, Irvine, CA (US)

(73) Assignee: Google Inc., Mountain View, CA (US)

(21) Appl. No.: 13/248,811

(22) Filed: Sep. 29, 2011

(51) Int. Cl. G06F 17/30

(52) U.S. Cl. CPC G06F 17/30041; G06F 17/30876; G06F 17/30106; G06F 17/30091; G06F 17/30598; G06F 17/30241

(57) ABSTRACT

Methods, systems, and apparatus, including computer programs encoded on a computer storage medium, for automatically associating collections of media files are provided. A first tying-identifier is determined from at least one media file in a first media collection. A second tying-identifier is determined from at least one media file in a second media collection. The first tying-identifier is then compared to the second tying-identifier. The first media collection and the second media collection are then associated together based on the similarity between the first tying-identifier and the second tying-identifier.

### FIELD OF THE INVENTION

The field of the invention generally relates to tying collections of media files.

### BACKGROUND

At events, such as weddings, conferences, and other gatherings, media files are often captured by people using a variety of capture devices. Because each device may have different capabilities and each person may have a different level of technical knowledge, no easy way exists to tie the various collections of media files together. Some websites currently offer a user the ability to upload and share individual collections of photographic images. Associating a user's collection of media files to another user's collection of media files, however, does not automatically occur upon uploading the collections to the website.

### BRIEF SUMMARY

The embodiments described below include systems, methods, and computer program products for associating disparate collections of media files. A first tying-identifier is determined from at least one media file in a first media collection. A second tying-identifier is determined from at least one media file in a second media collection. The first tying-identifier is then compared to the second tying-identifier. The first media collection and the second media collection are then associated together based on the similarity between the first tying-identifier and the second tying-identifier.

Further embodiments and features, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the information contained herein.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1A is an example environment that may be used to automatically link collections of media files.

FIG. 1B is an example diagram that describes a system embodiment for automatically tying collections of media files using the system described in FIG. 1A.

FIG. 1C is an example diagram that describes a system embodiment for automatically tying collections of media files using the system described in FIG. 1A.

FIG. 2 is a flowchart illustrating an exemplary method for automatically linking collections of media files.

FIG. 3 is a system diagram that can be used to implement embodiments described herein.

### DETAILED DESCRIPTION

The present embodiments described below include systems, methods and computer program products for tying together disparate media collections from a plurality of users. The embodiments are described herein with reference to illustrations for particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

The embodiments described herein make reference to the term “media file.” The term “media file(s)”, as used herein, is intended to include all digital image files (e.g., JPEG, GIF, BMP, PNG, etc.), all digital video files (i.e., MPEG, WMV, AVI, H.264, etc.), and all digital audio files (e.g., mp3, AIFF, AAC, WAC, etc.). The embodiments described herein also make reference to the term “media collection(s).” The term “media collection(s),” as used herein, is intended to include a grouping of one or more media files.

This Detailed Description is divided into sections. The first section describes example system embodiments that may be used to tie disparate collections of media files together, according to embodiments of the present invention. The second section describes example method embodiments for tying together disparate collections of media files, according to embodiments of the present invention. The third section describes additional alternative embodiments as well as how a plurality of users may utilize various embodiments. Finally, the fourth section describes an example computer system that may be used to carry out the embodiments described herein.

### Example System Embodiments

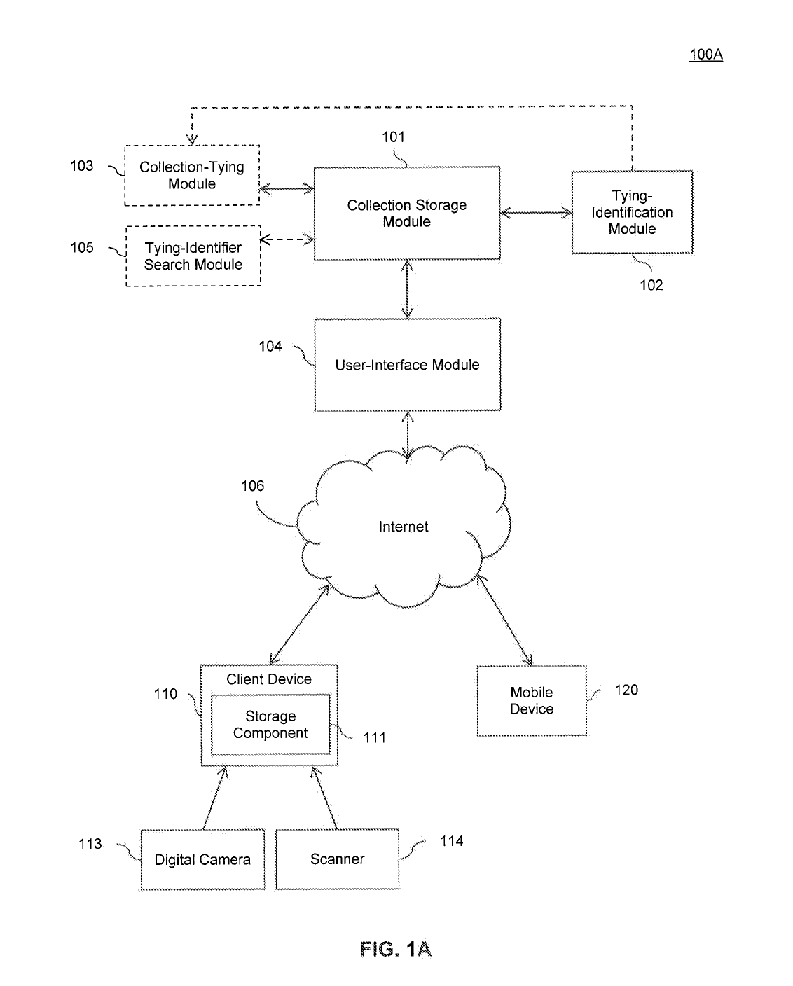

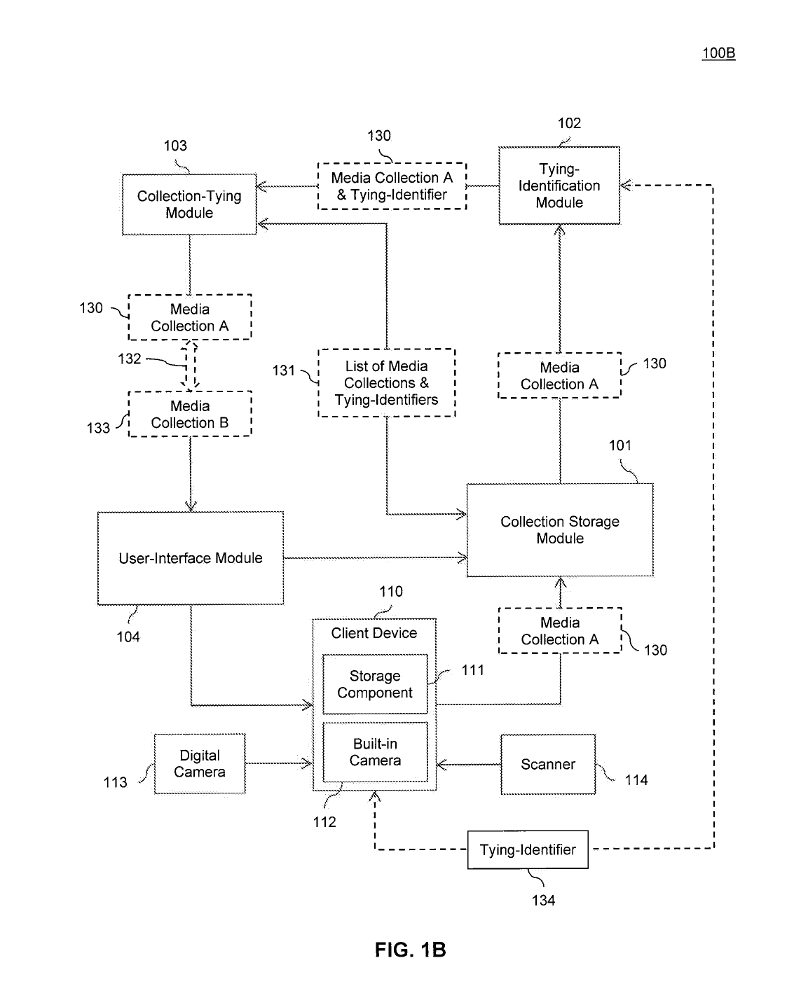

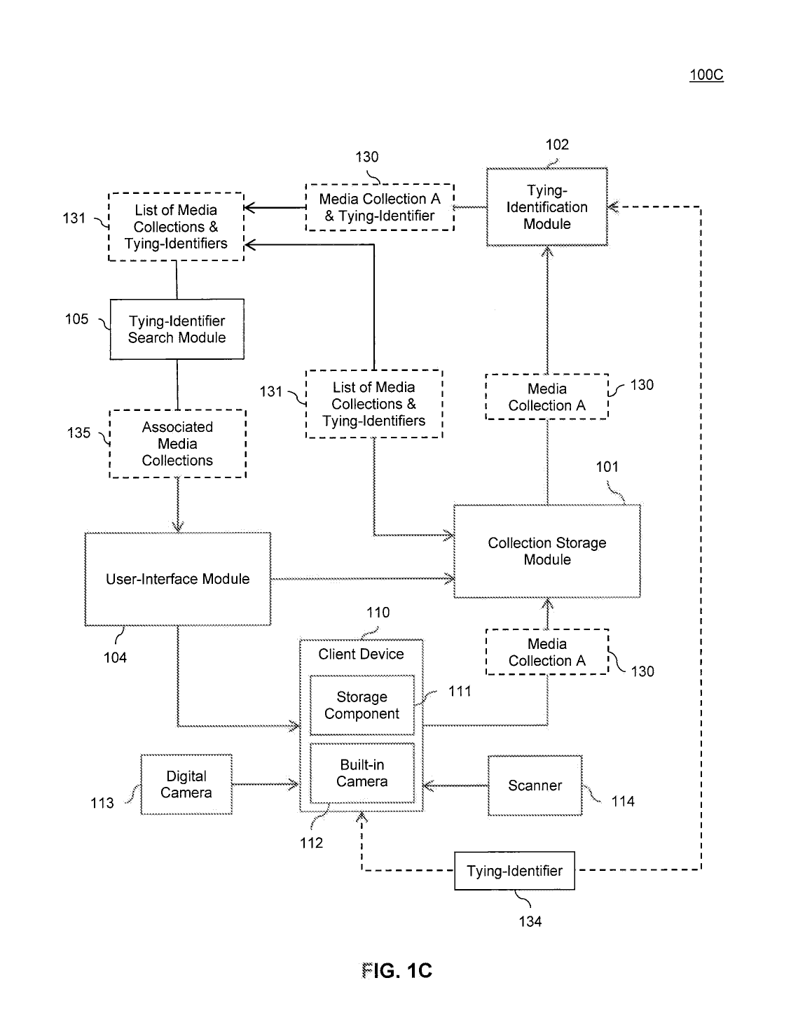

FIG. 1A is an example system environment 100A that may be used to automatically link collections of media files. System 100A includes collection storage module 101, tying identification module 102, collection tying module 103, user-interface module 104, tying-identifier search module 105, Internet 106, client device 110, storage component 111, digital camera 113, scanner 114, and mobile device 120.

Client device 110 is configured to receive and store a collection of photographic images. Media collections may be received from any media capture device including, for example, digital camera 113 or scanner 114. Media collections may also be created via client device 110 by organizing previously acquired media files into a media collection. Media collections may be stored on storage component 111. In this embodiment, storage component 111 is included in client device 110. In another embodiment, however, storage component 111 may be an external device connected to client device 110 or may be a storage system accessible via Internet 106.

Media collections may also be stored on mobile device 120. Mobile device 120 can include cellular telephones, tablet devices, portable computers, e-book readers, or any mobile computing device capable of acquiring or storing one or more types of media files. Mobile device 120 may acquire media files via a built-in camera or from an external source such as a memory card or Internet storage systems.

In one embodiment, client device 110 and mobile device 120 may both send media collections via Internet 106 to user-interface module 104. User-interface module 104 allows a user to view and modify media collections associated with a user profile before saving the media collection on collection storage server 101.

In another embodiment, client device 110 and mobile device 120 may bypass user-interface module 104 and send media collections directly to collection storage server 101.

Media collections stored on collection storage server 101 are processed by tying identification module 102 to determine one or more tying-identifiers. Tying-identifiers can be determined from one or more media files in each media collection and each media collection may have one or more tying-identifiers. Tying-identifiers can be determined using any number of methods—some of which will be described further in reference to FIG. 1B.

In one embodiment, media collections with tying-identifiers are processed by collection tying module 103. If at least two media collections have similar tying-identifiers, the media collection will be associated together. A number of methods may be used to determine whether tying-identifiers between various media collections are similar. These methods are described further in reference to FIG. 1B.

Any linking associations created by collection tying module 103 may be stored on collection storage server 101. The linking associations may then be viewed and/or modified by a user via user-interface module 104. A number of methods may be used to create linking associations. These methods are described further in reference to FIGS. 1B and 1C.

In another embodiment, media collections with tying-identifiers are processed by tying-identifier search module 105. Tying-identifier search module may be configured to analyze a list of media collections to locate media collections having similar tying-identifiers. Any media collections that are located may be displayed to a user or otherwise associated together. This embodiment is described further in reference to FIG. 1C.

FIG. 1B is an example diagram that describes a system 100B for automatically tying collections of media files using the system described in FIG. 1A. System 100B includes collection storage module 101, tying identification module 102, collection tying module 103, user-interface module 104, client device 110, storage component 111, built-in camera 112, digital camera 113, scanner 114, media collection A 130, list 131, link 132, media collection B 133, and tying-identifier 134.

In one embodiment, media collection A 130 is a collection of media files that includes at least one photographic image. Media collection a 130 may be acquired from any digital capture device such as, for example, built-in camera 112, digital camera 113, or scanner 114. Media collection A 130 may also be created by a user associating existing media files together. Once media collection A 130 is acquired, it may reside on client device 110 or storage component 111.

Collection storage module 101 is configured to receive media collection A 130 from client device 110. Once received, collection storage module 101 may store media collection A 130 and associate it with a user profile. Collection storage module 101 will then make media collection A 130 available to tying identification module 102 for processing.

Tying identification module 102 will analyze media collection A 130 to determine if one or more tying-identifier is present for each media file. Tying-identifiers can be generated based on metadata associated with a media file or, for image or video files, one or more captured objects.

In one embodiment, a tying-identifier can be determined from metadata associated with a media file. Metadata may be in any format. For image files, for example, metadata formats can include IPTC Information Interchange Model IIM, IPTC Core Schema for XMP, Extensible Metadata Platform (XMP), Exchangeable Image File Format (EXIF), etc. Metadata can include the time the media file was captured or the geolocation where the media file was captured. For example, a tying-identifier may consist of a 32 bit data field where the first 16 bits are associated with the time of capture and the last 16 bits are associated with the geolocation of capture. This tying-identifier may be generated for each media or only the first media file in media collection A 130.

In another embodiment, tying-identifier 134 may be requested from tying identification module 102 and/or stored in a device capable of capturing media files. Each time the device captures a media file, tying-identifier 134 will be stored in the metadata associated with the media file. In one example, a group of users may request and share tying-identifier 134. Each user may then enter tying-identifier 134 into his/her capture device so that the device will insert tying-identifier 134 into metadata associated with one or more media files at the time of capture. In another example, tying-identifier 134 may be requested from tying identification module 102 and printed and displayed. Users may then capture an image or video of printed tying-identifier 134. Tying-identifier 134 may then be determined from the image or video files when the files are processed by tying identification module 102.

In another embodiment, tying identification module 102 can determine a tying-identifier based on one or more objects captured in an image or video file. Examples of objects captured in an image or video file for which tying-identifiers can be determined can include, for example, bar codes, Quick Response (“QR”) codes, or other print material such as business cards, posters, advertisements, or automobile license plates. Tying-identifiers may also be determined from other objects captured in the files such as buildings or faces. One of skill in the art will readily understand how to determine or generate tying-identifiers from one or more objects captured in an image or video file.

In another embodiment, tying identification module 102 can determine a tying-identifier based on a combination of metadata associated with an image or video file and the objects that are captured in the file.

Once tying identification module 102 has finished processing media collection A 130, any determined tying-identifiers will be associated with media collection A 130 and stored at collection storage server 101. The user may then access the media files in media collection A 130 and any associated tying-identifiers. The user may also modify the associated tying-identifiers. Media collection A 130 and the associated tying-identifiers may then be made available to collection tying module 103.

Collection tying module 103 can be configured to access collection storage module 101 to retrieve media collection A 130 and a list of additional media collections. These additional media collections are included in list 131. The media collections in list 131 may be associated with the same user that is associated with media collection A 130 or different users. Collection tying module 103 can also be configured to access the tying-identifiers that are associated with both media collection A 130 and the media collections in list 131.

The tying-identifiers accessed by collection tying module 103 may then be processed to determine if any tying-identifiers associated with the media collections in list 131 are similar to the tying-identifiers associated with media collection A 130. In one embodiment, tying-identifiers may be similar if a portion of the identifiers meets a similarity threshold. In another embodiment, tying-identifiers may be similar only if the identifiers match exactly.

In one embodiment, if collection-tying module 103 determines that a tying-identifier associated with media collection A 130 and one or more tying-identifiers associated with the media collections in list 131 meet a similarity threshold, link 132 will be created to associate the corresponding media collections. For example, if media collection A 130 and media collection B 133 having similar tying-identifiers, media collection A 130 will be associated with media collection B 133 via link 132.

In another embodiment, link 132 can include a unique identifier that can be associated with each media collection. The unique identifier may be based on the similar tying-identifiers. In an embodiment, link 132 can include a data structure storing a reference pointer, address, or locator to each linked media collection. The methods for linking media collections will be readily understood by a person of skill in the art.

Once collection tying module 103 has completed associating media collection A 130 to corresponding media collections in list 131, media collection A 130 and any associated media collections can be displayed to a user via user-interface module 104. User-interface module 104 may also be configured to allow the user to modify any media collection associations. After the user completes viewing and/or modifying the associated media collections, media collection A 130, the associated tying-identifiers, and any associations can be stored to a server via collection storage module 101.

In another embodiment, link 132 can include copying or moving the media files in each media collection into a single media collection. In this example, the single, combined media collection can be stored in a virtual folder on collection storage module 101. Additionally, the combined media collection may be viewed and/or modified by the user via user-interface module 104.

FIG. 1C is an alternative embodiment to system 100B. FIG. 1C is an example diagram that describes system 100C for automatically tying collections of media files using the system described in FIG. 1A. System 100C includes collection storage module 101, tying identification module 102, user-interface module 104, tying-identifier search module 105, client device 110, storage component 111, built-in camera 112, digital camera 113, scanner 114, media collection A 130, list 131, associated media collections 135, and tying-identifier 134.

In one embodiment, client device 110 is configured to store and manage collections of media files. For example, media collection A 130 is a collection of media files that includes at least one photographic image. Media collection A 130 may be acquired or combined from any source described in reference to system 100B. Media collection A 130 is then made available to collection storage module 101.

Collection storage module 101 is configured to receive media collection A 130 from client device 110. Once received, collection storage module 101 may store media collection A 130 and associate it with a user profile. Collection storage module 101 will then make media collection A 130 available to tying identification module 102 for processing.

Tying identification module 102 will analyze media collection A 130 to determine if one or more tying-identifier is present for each media file. The embodiments described above in reference to tying identification module 102 of system 100B may also implemented using tying identification module 102 of system 100C.

Once tying identification module 102 has finished processing media collection A 130, any determined tying-identifiers may be associated with media collection A 130 and stored at collection storage server 101. The user may then access the media files in media collection A 130 and any associated tying-identifiers. The user may also modify the associated tying-identifiers. Media collection A 130 and the associated tying-identifiers may then be made available to tying-identifier search module 105.

Tying-identifier search module 105 is configured to analyze a list of disparate media collections to determine whether any tying-identifiers in the disparate media collections meet a similarity threshold. In one embodiment, media collection A 130 is combined with a list of media collections 131 retrieved from collection storage module 101. List 131 may then be analyzed by tying-identifier search module to determine if any media collection has a tying-identifier similar to the tying-identifiers in media collection A 130. In another embodiment, media collection A 130 is not combined with list 131. Instead, tying-identifier search module 105 receives one or more tying-identifiers associated with media collection A 130 and list 131. Tying-identifier search module 105 may then analyze or search list 131 to locate any media collections with tying-identifiers that are similar to the tying code received from media collection A 130.

Once tying-identifier search module 105 locates media collections with similar tying-identifiers, the media collections may then be associated with media collection A 130, represented here by associated media collections 135. Any method or embodiment describe above in reference to system 100B may be used to associate media collection A 130 to other media collections. Additionally, as described in reference to system 100B.

The associated media collections 135 may then be displayed to the user via user-interface module 104. The user may then view the associated media collections 135 and add or remove media collections in the associated collection.

The embodiments in FIGS. 1A, 1B, and 1C are examples of systems that automatically tie collections of photographic media. Collection storage module 101, tying identification module 102, collection tying module 103, user-interface module 104, and tying-identifier search module 105 may be implemented as hardware or software running on either a single computer system or multiple computer systems connected via a local or remote network.

The embodiments discussed above are merely examples and are not intended to limit the design of a system for linking collections of photographic images. One of skill in the art will readily understand useful combinations of the various modules and how to accomplish the functions of each module in the most efficient manner.

### Example Method Embodiments

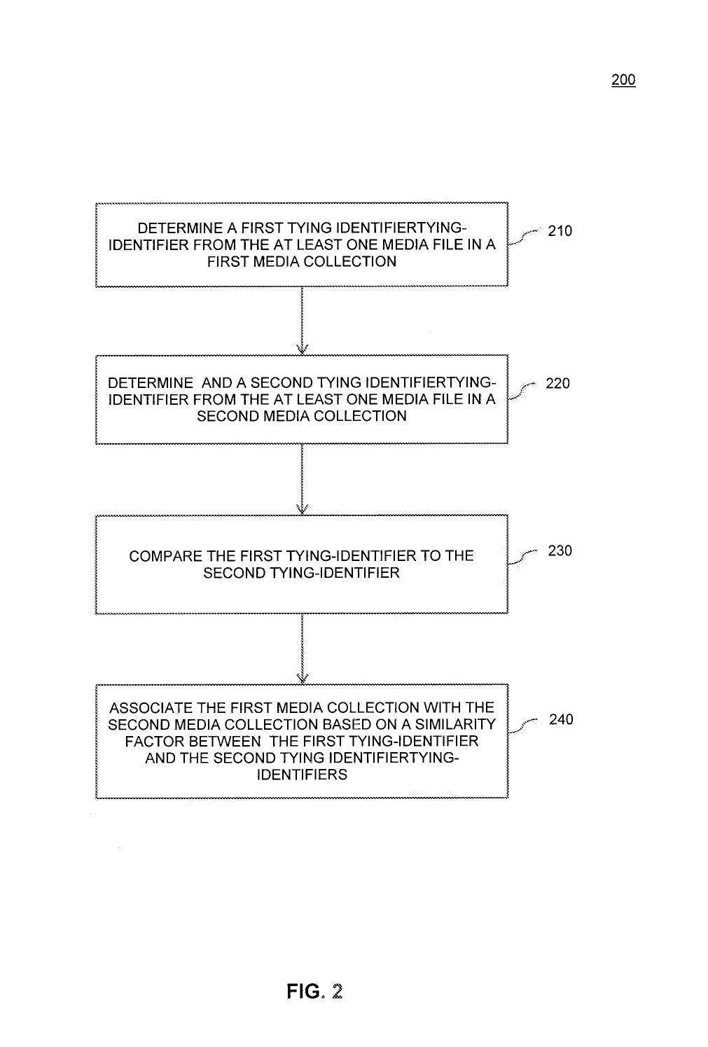

FIG. 2 is a flowchart illustrating an exemplary method 200 for automatically linking collections of media files. Method 200 includes steps 210, 220, 230, 240.

Method 200 determines a first tying-identifier from the at least one media file in a first media collection (Step 210). Method 200 also determines a second tying-identifier from the at least one media file in a second media collection (Step 220). In some embodiments, the images in the collection are analyzed until one tying-identifier is determined. In another embodiment, multiple tying-identifiers may be determined from each media file in the collection. Tying identification module 102 embodied in systems 100A and 100B, for example, may carry out steps 210 and 220.

After the first and second tying-identifiers have been determined, method 200 compares the first tying-identifier to the second tying-identifier (Step 230). Method 200 then associates the first media collection with the second media collection based on a similarity between the first tying-identifier and the second tying-identifier (Step 240). Tying-identifiers can be similar if a portion of the tying-identifiers match. Steps 230 and 240 may be carried out by collection tying module 103 embodied in systems 100A, 100B, and 100C for example.

In one embodiment, the tying-identifiers may have a portion dedicated to the source from which the tying-identifier was determined. In this case, a tying-identifier based on, for example, a combination of time and geolocation may have a portion that indicates the time and a portion that indicates the geolocation. Tying-identifiers from disparate media collections in this example may not be exactly the same but, instead, may have similar time portions and similar geolocation portions. The time and geolocation portions may be similar enough to create a link between the image collections.

In another embodiment, tying-identifiers will be similar only if they match. For example, disparate media collections may each include an image or video file, for example, of the same bar code or QR code. Because the file will produce the same tying-identifier for each media collection, links will only be created when tying-identifiers match.

In some embodiments, a user-interface may be provided that allows a user to modify either the tying-identifiers associated with an media collection or the links between media collections. The user-interface may also allow a user to associate new linking identifiers or tying-identifiers with a media collection in order to link to additional media collections.

In some embodiments, method 200 can be implemented using the systems embodied in 100A, 100B, and 100C. These embodiments, however, are merely exemplary and are not intended to limit the way tying-identifiers can be determined or how image collections are linked. One of skill in the art will readily understand other useful embodiments for determining a tying-identifier and linking disparate media collections.

### Example Alternative Embodiments

The various embodiments described above can be used and/or combined in various ways. For example, a tying-identifier may be requested from tying identification module 102 and printed and displayed at an event such as a wedding, a conference, or another gathering. The tying-identifier may include, for example, a QR code or any other type of bar code or unique identification scheme.

Users attending the event can use any capture device to capture an image or video file of the displayed tying-identifier. The users may then continue to capture media files during the event. At some point after or even during the event, the users may upload the media collections captured during the event to a server. The server may implement one or more of the modules of systems 100A, 100B, or 100C including collection storage module 101, tying identification module 102, collection tying module 103, user-interface module 104, and tying-identifier search module 105. The server may be configured to store user profiles and associated any uploaded media collections with a user profile. The server may also be configured to allow a user to view or modify any media collection associated with his/her user profile.

Once the users have uploaded one or more media collections that include the tying-identifier captured in an image or video, tying identification module 102, implemented on the server, can analyze each image or video in each media collection to locate the tying-identifier file and generate the tying-identifier from the file. The generated tying-identifier may be associated with the corresponding media collection and stored on the server. The server may then compare the tying-identifiers generated from each media collection to determine if any two meet a similarity threshold. The similarity threshold can determine if the similarity is acceptable. In this embodiment, an acceptable threshold will be limited to an exact match due to the tying-identifiers being based a QR code, bar code, or other unique identification scheme.

In one embodiment, if two or more media collections are found to have acceptably similar tying-identifiers, collection tying module 103 will create a link between the corresponding media collections. For example, a link may include a unique linking identifier. The unique linking identifier may be based on the tying-identifier or may include, for example, a reference address such as a URL or a reference pointer. The unique linking identifier will be associated with each similar media collection and stored at the server.

In another embodiment, tying-identifier search module 105, implemented on a server, will analyze some or all of the media collections stored on the server to locate media collections having similar tying-identifiers. Once the media collections are located, the locations may be placed in a data structure or address table and stored on the server.

A user-interface may be provided that allows a user to view and/or modify the media collections associated with their user profile and any associations with other media collections. The user-interface may also allow the user to view any associated media collections.

In another example, a group of people exploring a tourist destination plans to link and share media collections that will be captured on various capture devices. Since it is not convenient to share a pre-fetched tying-identifier, each user will capture an image of the same object within a short duration, for example, 20 minutes. Alternatively, if each capture device is equipped with equipment capable of determining a geolocation, each user may capture a media file at the same or similar location within a short duration. The resulting image will later be used to generate a tying-identifier for each media collection.

Once each media collection is uploaded to a server, tying identification module 102 implemented on the server will analyze each media file to generate tying-identifiers. In one embodiment, for example, tying-identifiers will be generated from a combination of the time field stored in the metadata associated with each image or video file and any objects captured in each image or video file. If two types of data are desired to be associated with a tying-identifier, the tying-identifier may represent both types of data. For example, if a tying-identifier consists of a 32-bit number, the first 16 bits may be used to represent the time the media was captured and the last 16 bits may be used to represent an object that was captured.

In one embodiment, once each media collection is analyzed, collection tying module 103, implemented on the server, will compare the tying-identifiers generated for each media collection to determine if any tying-identifiers from disparate media collections meet a similarity threshold. Because the tying-identifiers in this example are based on a combination of time and an object, they will be similar, but likely not the same. Thus, collection tying module 103 will link media collections together based on a flexible similarity threshold. For example, the last 16 bits representing the object will likely be the same. The first 16 bits representing the time of capture, however, may be similar but not a match. Based on the likely match of the last 16 bits and the short duration calculated from the first 16 bits, the server links two corresponding media collections.

In another embodiment, tying-identifier search module 105, implemented on a server, will analyze some or all of the media collections stored on the server to locate media collections having similar tying-identifiers. The method describe in the previous embodiment may be used to determine whether tying-identifiers meet a similarity threshold. Once the media collections are located, the locations may be placed in a data structure or address table and stored on the server.

These alternative embodiments may be implemented using the system embodiments 100A, 100B, or 100C. Further, these alternative embodiments are merely exemplary and are not intended to limit the methods for determining tying-identifiers or how the image collections are linked. One of skill in the art will readily understand other useful methods for determining a tying-identifier and linking disparate media collections.

### Example Computer System

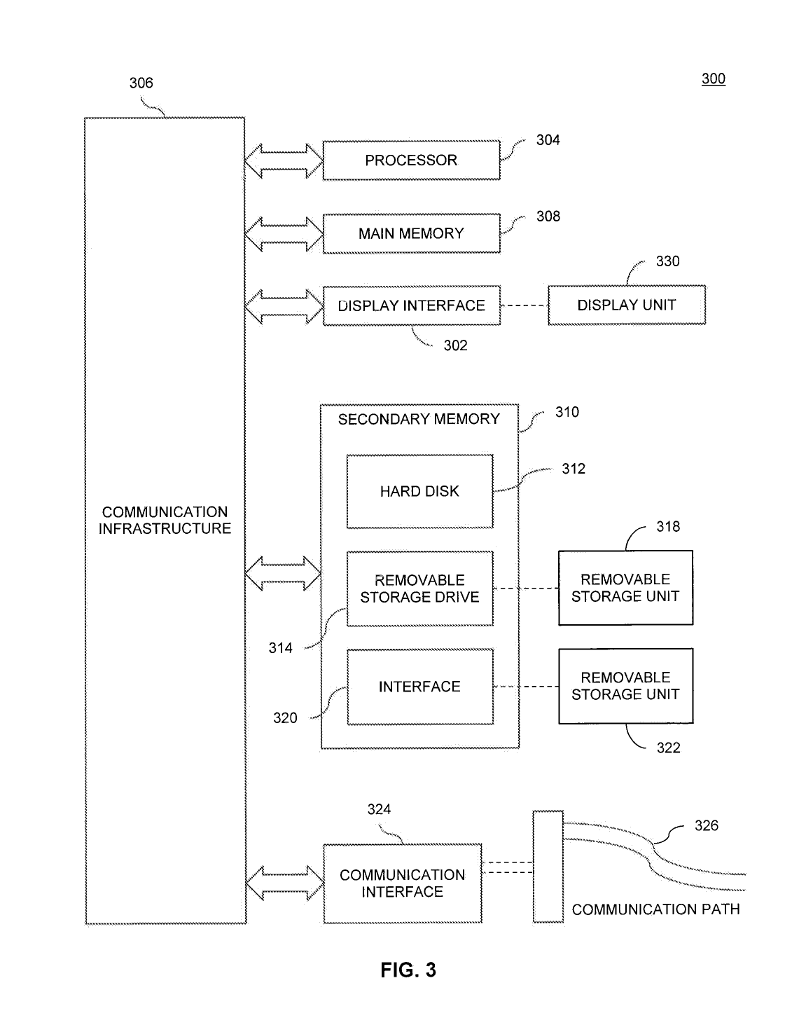

FIG. 3 illustrates an example computer system 300 in which embodiments of the present disclosure, or portions thereof, may be implemented as computer-readable code. For example, collection storage module 101, tying identification module 102, collection tying module 103, and tying-identifier module 105 may be implemented in computer system 300 using hardware, software, firmware, tangible computer readable media having instructions stored thereon, or a combination thereof and may be implemented in one or more computer systems or other processing systems. Hardware, firmware, software, or any combination of such may embody any of the modules, components, and steps in FIGS. 1A, 1B, 1C, and 2.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

Various embodiments are described in terms of this example computer system 300. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 304 may be a special purpose or a general-purpose processor device. As will be appreciated by persons skilled in the relevant art, processor device 404 may also be a single processor in a multi-core/multiprocessor system, such system operating alone, or in a cluster of computing devices operating in a cluster or server farm. Processor device 304 is connected to a communication infrastructure 306, for example, a bus, message queue, network, or multi-core message-passing scheme.

Computer system 300 also includes a main memory 308, for example, random access memory (RAM), and may also include a secondary memory 310. Secondary memory 310 may include, for example, a hard disk drive 312, removable storage drive 314. Removable storage drive 314 may include a floppy disk drive, a magnetic tape drive, an optical disk drive, a flash memory, or the like. The removable storage drive 314 reads from and/or writes to a removable storage unit 318 in a well-known manner. Removable storage unit 318 may include a floppy disk, magnetic tape, optical disk, etc. which is read by and written to by removable storage drive 314. As will be appreciated by persons skilled in the relevant art, removable storage unit 318 includes a computer usable storage medium having stored therein computer software and/or data.

In alternative implementations, secondary memory 310 may include other similar means for allowing computer programs or other instructions to be loaded into computer system 300. Such means may include, for example, a removable storage unit 322 and an interface 320. Examples of such means may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to computer system 300.

Computer system 300 may also include a communications interface 324. Communications interface 324 allows software and data to be transferred between computer system 300 and external devices. Communications interface 324 may include a modem, a network interface (such as an Ethernet card), a communications port, a PCMCIA slot and card, or the like. Software and data transferred via communications interface 324 may be in the form of signals, which may be electronic, electromagnetic, optical, or other signals capable of being received by communications interface 324. These signals may be provided to communications interface 324 via a communications path 326. Communications path 326 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 318, removable storage unit 322, and a hard disk installed in hard disk drive 312. Computer program medium and computer usable medium may also refer to memories, such as main memory 308 and secondary memory 310, which may be memory semiconductors (e.g. DRAMs, etc.).

Computer programs (also called computer control logic) are stored in main memory 308 and/or secondary memory 310. Computer programs may also be received via communications interface 324. Such computer programs, when executed, enable computer system 300 to implement the present embodiments as discussed herein. In particular, the computer programs, when executed, enable processor device 304 to implement the processes of the present invention, such as the stages in the methods illustrated by flowchart 200 of FIG. 2, discussed above. Accordingly, such computer programs represent controllers of the computer system 300. Where an embodiment of invention is implemented using software, the software may be stored in a computer program product and loaded into computer system 300 using removable storage drive 314, interface 320, and hard disk drive 312, or communications interface 324.

Embodiments may also be directed to computer program products including software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The Summary and Abstract sections may set forth one or more but not all exemplary embodiments of the present invention as contemplated by the inventor(s), and thus, are not intended to limit the present invention and the appended claims in any way.

The present embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer system for associating collections of media files, comprising:
a tying-identification module configured to:
generate a unique tying-identifier;
provide the unique tying-identifier to one or more first users;
determine whether the unique tying identifier is present in a first media collection, wherein the first media collection includes a plurality of first media files; and
determine an additional tying identifier in a second media collection, wherein the additional tying identifier is different from the unique tying identifier, and wherein the second media collection includes a plurality of second media files and the additional tying identifier is based on metadata associated with at least one second media file of the plurality of second media files;
a collection-tying module configured to associate the first media collection for which the unique tying-identifier is present with the second media collection for which the additional tying identifier different than the unique tying identifier is determined when the unique tying-identifier is determined to be present in the first media collection and the additional tying identifier from the second media collection meets a similarity threshold with the unique tying-identifier from the first media collection;
at least one memory unit configured to store at least one of the tying-identification module or the collection-tying module; and
at least one computer processor configured to execute at least one of the tying-identification module or the collection-tying module.

2. The system of claim 1, wherein the tying-identification module is further configured to determine the additional tying-identifier based on a combination of the metadata associated with an image or video file of the plurality of second media files and one or more objects captured in the image or video file.

3. The system of claim 1, wherein the tying-identification module is further configured to determine whether the unique tying-identifier is present in the first media collection based on one or more objects captured in at least one of the plurality of first media files in the first media collection.

4. (canceled)

5. The system of claim 1, wherein the tying-identification module is further configured to determine the additional tying-identifier based on geolocation data in the metadata associated with the image or video file of the at least one of the second media.

6. (canceled)

7. The system of claim 1, further comprising:
a user-interface module configured to modify an association between the first media collection and the second media collection in response to user input.

8. The system of claim 7, wherein the user-interface module is further configured to cause the unique tying-identifier to be generated based at least in part on user input.

9. (canceled)

10. The system of claim 1, wherein the collection tying module is further configured to display the first media collection and the second media collection at a common user-interface.

11. The system of claim 1, wherein the collection tying module is further configured to:
combine the first media collection and the second media collection into a third media collection; and
store the third media collection.

12. A computer-implemented method for associating collections of media files, comprising:
generating a unique tying-identifier;
providing the unique tying-identifier to one or more first users;
determining, by at least one processor, whether the unique tying-identifier is included in one or more media collections of a plurality of media collections, wherein each of the one or more media collections includes a plurality of media;
determining, by at least one processor, an additional tying identifier in an additional media collection of the plurality of media collections, wherein the additional tying identifier is different from the unique tying identifier, and wherein the additional media collection includes a plurality of additional media files and the additional tying identifier is based on metadata associated with at least one media file of the plurality of additional media files; and
associating each of the one or more media collections together that includes the unique tying-identifier along with the additional media collection for which the additional tying identifier different than the unique tying identifier is determined when the additional tying identifier meets a similarity threshold with the unique tying identifier.

13. (canceled)

14. The method of claim 12, wherein determining the additional tying-identifier comprises determining the additional tying-identifier based on a combination of the metadata associated with an image or video file of the plurality of additional media files and one or more objects captured in the image or video.

15. The method of claim 12, wherein determining whether the unique tying-identifier is included in the one or more media collections comprises determining whether the unique tying-identifier is present in the first media collection media based on one or more objects captured in at least one media file included in a particular collection.

16. (canceled)

17. The method of claim 12, wherein determining whether the additional tying-identifier meets a similarity threshold with the unique tying identifier comprises determining the additional tying-identifier based on a geolocation data that indicates where the image or videos file of the plurality of second media files was captured and comparing the geolocation data with location information associated with the unique tying identifier.

18. The method of claim 12, further comprising:
modifying an association between each of the one or more media collections that includes the unique tying-identifier and the additional media collection based at least in part on user input.

19. The method of claim 12, wherein generating the unique tying identifier comprises:
generating the unique tying-identifier based at least in part on user input.

20. (canceled)

21. The method of claim 12, further comprising displaying the associated media collections at a common user-interface.

22. The method of claim 12, further comprising:
combining each of the one or more media collections together that includes the unique tying-identifier along with the additional media collection when the additional tying identifier meets the similarity threshold with the unique tying identifier into a combined media collection; and
storing the combined media collection.

23. An apparatus comprising a non-transitory computer readable medium encoding instructions thereon that, in response to execution by a computing device, causes the computing device to perform operations comprising:
generating a unique tying-identifier;
providing the unique tying-identifier to one or more first users;
determining whether the unique tying identifier is present in a first media collection, wherein the first media collection includes a plurality of first media files;
determining an additional tying identifier in a second media collection, wherein the additional tying identifier is different from the unique tying identifier, and wherein the second media collection includes a plurality of second media files and the additional tying identifier is based on metadata associated with at least one second media file of the plurality of second media; and
associating the first media collection for which the unique tying-identifier is present with the second media collection for which the additional tying identifier different than the unique tying identifier is determined when the unique tying-identifier is determined to be present in the first media collection and the additional tying identifier from the second media collection meets a similarity threshold with the unique tying-identifier from the first media collection.

24. (canceled)

25. The apparatus of claim 23, wherein the operations comprising determining the additional tying-identifier in the second media collection includes operations comprising determining the unique tying-identifier from metadata associated with an image or video file of the plurality of second media files and one or more objects captured in the image or video file.

26. The apparatus of claim 23, wherein the operations comprising determining whether the unique tying-identifier is present in the first media collection further include operations comprising determining whether the unique tying-identifier is present in the first media collection based one or more objects captured in the at least one of the plurality of first media files in the first media collection.

27. (canceled)

28. The apparatus of claim 23, wherein the operations comprising determining the additional tying-identifier further include operations comprising determining the additional tying-identifier based on geolocation data in the metadata associated with the image or video file of the plurality of second media files that indicates where the image or video file of the -second media collection was captured.

29. The apparatus of claim 23, further including operations comprising:
modifying the association between the first media collection and the second media collection based at least in part on user input.

30. The apparatus of claim 23, further including operations comprising:
generating the unique tying-identifier based at least in part on user input.

31. (canceled)

32. The apparatus of claim 23, further including operations comprising displaying the first media collection and the second media collection at a common user-interface.

33. The apparatus of claim 23, further including operations comprising:
combining the first media collection and the second media collection into a third media collection; and
storing the third media collection.
